(19) United States
(12) Patent Application Publication
(10) Pub. No.: US 2003/0207105 A1
(43) Pub. Date: Nov. 6, 2003

(54) Backing for adhesive tape and such tape

(75) Inventors: Joan M. Strobel, Maplewood, MN (US); Thomas P. Hanschen, St. Paul, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/445,531

(22) Filed: May 27, 2003

Related U.S. Application Data
(63) Continuation of application No. 09/331,044, filed on Jun. 16, 1999, now abandoned.
Application No. 09/331,044 is a 371 of international application No. PCT/US98/24784, filed on Nov. 20, 1998.

(51) Int. Cl. B32B 7/12; C09J 7/02

(52) U.S. Cl. 428/343

(57) ABSTRACT

Films useful as tape backings, and more particularly biaxially oriented polypropylene film backings and tapes including such backings. A brittle, biaxially oriented polypropylene film is provided by minimizing the nucleation density in the extruded and quenched polypropylene polymer cast sheet followed by maximizing the spherulitic growth rate of the resultant quenched polymer. The cast sheet so formed is stretched at higher-than-normal temperatures in the subsequent orientation steps for producing the biaxially oriented polypropylene film. This produces a more brittle film.

The polypropylene composition, extrusion temperature, cast roll temperature (i.e., quench temperature), and stretch temperature and other parameters are selected in accordance with the teachings herein such that the resulting backing or tape has the following preferred properties, taken individually or in any preferred combination: A) an MD tensile energy at break of up to about 90 N-mm/mm³; B) an MD elongation to break of at least 70%; C) a puncture energy of up to about 130 N-mm; D) a dispense energy of up to about 350 N-cm/cm²; E) when disposed on commercially available serrated plastic or metal dispenser blades, the serrated edge of the tape or backing closely follows the contour of the dispensing blade; and F) an ability to be torn by hand.

### TECHNICAL FIELD

The present invention relates generally to films useful as tape backings, and more particularly to biaxially oriented polypropylene film backings and tapes including such backings.

### BACKGROUND OF THE INVENTION

Biaxially oriented polypropylene films are typically used in applications in which the combination of low cost and excellent mechanical and optical properties are advantageous. Some applications for such films include packaging overwraps and adhesive tape substrates.

An important factor determining the properties of a semi-crystalline polymer, such as polypropylene, is the packing order of the polymer chains. Crystallization is a means to control the degree and morphology of the packing of polymer chains. The degree and nature of this order has a tremendous influence on the final mechanical properties of the material.

The important parameters controlling crystallization in polypropylene are: (1) the total crystallinity, (2) the number of crystalline entities per unit volume, also known as the nucleation density, (3) the average diameter or size of the crystallites or crystallite aggregates (called spherulites), and (4) the average distance between the crystalline entities. When extruding and quenching polypropylene polymer from the melt, the polymer crystallizes into a lamellar structure that will lead to a spherulitic macrostructure in the finished cast sheet. These lamellar and spherulitic structures are joined via tie molecules; tie molecules are the parts of polymer chains extending from one lamella to another. These tie molecules concentrate and distribute stresses throughout the finished material.

The prior art suggests that it is advantageous for the spherulitic macrostructure generated during the quenching of a polymer to be as small as possible. To achieve this, it has been suggested that the number of crystalline entities per unit volume must be large and therefore the “undercooling” of the cast polymer by quenching must be high and rapid. In addition, it has been suggested that it is desirable to maximize the rate of growth of the lamellar and spherulitic structures as well. D. W. van Krevelen, Chimia, 32 (8), August, 1978. Van Krevelen has developed a universal master curve relating the rate-of-growth of spherulites as a function of the ratio of the crystallization temperature to the polymer melt-temperature. For polypropylene, Van Krevelen reports that the maximum spherulitic growth-rate occurs at a crystallization temperature of approximately 90° C.

Commercially available pressure sensitive adhesive tapes are usually provided in a roll form on a tape dispenser (see, for example, U.S. Pat. Nos. 4,451,533 and 4,908,278). Tape dispensers typically have either a metal or a plastic serrated cutting blade. “Severability” of adhesive tape is defined as the amount of energy or work required to cut or sever a length of tape by pulling the tape over the serrations on the cutting edge of tape dispenser. Severability is also referred to is “dispensability.”

It is desirable that the severed tape does not chip, sliver, fracture or break in an unpredictable manner (see U.S. Pat. Nos. 4,451,533 and 4,908,278), so that a cleanly serrated cut edge is formed on the severed tape strip. Cleanly serrated edges are preferred for aesthetic reasons in applications such as gift wrapping, mending, and the like.

Severability is governed primarily by the mechanical properties of the backing of the adhesive tape. The ease with which an adhesive tape can be severed depends on the deformation resistance (toughness) of the tape backing film, also referred to as the substrate. Typically, this backing is coated or laminated with surface layers to provide an adhesive surface and a release surface. In most cases, the energy required to sever the tape is governed primarily by the backing, with little contribution by the adhesive and other layers or coatings.

Several attempts at providing desirable biaxially oriented polypropylene films are known from the art. See, for example, U.S. Pat Nos. 4,451,533; 5,252,389; and 5,366,796. Several attempts at providing tape backings that may be torn by hand (typically in the transverse direction of the backing) are known from the art. See, for example, U.S. Pat. Nos. 3,491,877; 3,853,598; 3,887,745; 4,045,515; 4,137,362; 4,139,669; 4,173,676; 4,393,115; 4,414,261; 4,447,485; 4,513,028; 4,563,441; 4,581,087; 5,374,482; and 5,795,834.

### SUMMARY OF THE INVENTION

A brittle, biaxially oriented polypropylene film is provided by minimizing the nucleation density in the extruded and quenched polypropylene polymer cast sheet followed by maximizing the spherulitic growth rate of the resultant quenched polymer. In addition, it is preferred to stretch the cast sheet so formed at higher-than-normal temperatures in the subsequent orientation steps for producing the biaxially oriented polypropylene film. This process produces a more brittle film.

The polypropylene composition, extrusion temperature, cast roll temperature (i.e., quench temperature), and stretch temperature and other parameters are selected in accordance with the teachings herein such that the resulting film, backing, or tape has the following preferred properties, taken individually or in any preferred combination:

A) an MD tensile energy-at-break of up to about 90 N-mm/mm³, more preferably from about 30 to 90 N-mm/mm³, still more preferably up to about 60 N-mm/mm³, and most preferably from about 30 to 60 N-mm/mm³;

B) an MD elongation to break of at least 70%, preferably from about 70 to 150%;

C) a puncture energy, when tested according to the Puncture Test described below, of up to about 130 N-mm, more preferably up to about 70 N-mm;

D) a dispense energy, when tested according to the Dispense Test described below of up to about 350 N-cm/cm²; more preferably up to about 170 N-cm/cm²;

E) when dispensed on commercially available serrated plastic or metal dispenser blades, the serrated edge of the tape or backing closely follows the contour of the dispensing blade;

F) an ability to be torn by hand in the TD, as defined by at least 50% success as described below. More preferably the backing or tape can be torn by hand with at least 90% success as described below, and most preferably 100%; and

G) an ability to be torn by hand in the MD, is defined by at least 50% success as described below. More preferably the backing or tape can be torn by hand with at least 90% success as described below, and most preferably 100%.

One aspect of the present invention provide an adhesive tape, comprising a backing and a layer of adhesive on the backing. The backing comprises polypropylene and has been biaxially oriented in the MD and TD of the backing. The backing is hand-tearable in the TD, and when the backing is severed on a serrated plastic cutting blade, the backing exhibits a serrated edge that closely corresponds to the contour of the blade.

In one preferred embodiment of the above tape, the backing comprises a monolayer.

In another preferred embodiment of the above tape, when the backing is severed according to the Dispense Test, the backing has an energy to sever in the MD of up to 350 N-cm/cm². Still more preferably, the backing has an energy to sever in the MD of up to 170 N-cm/cm².

In another preferred embodiment of the above tape, when the backing is tested according to the Puncture Test, the backing has a puncture energy of up to 130 N-mm. Still more preferably, the backing has a puncture energy of up to 70 N-mm.

In another preferred embodiment of the above tape, the backing has a tensile energy to break in the MD of up to 90 N-mm/mm³.

In another preferred embodiment of the above tape, the backing has a tensile elongation to break in the MD of at least 70%.

In another preferred embodiment of the above tape, the backing is hand-tearable in the MD.

In another aspect, the present invention provides an alternative adhesive tape comprising a backing and a layer of adhesive on the backing. The backing comprises polypropylene and has been biaxially stretched. The backing has a tensile energy to break in a first direction of up to 90 N-mm/mm³, and when the backing is severed on a serrated plastic cutting blade, the backing exhibits a serrated edge that closely corresponds to the contour of the blade.

On one preferred embodiment of the above tape, the backing comprises at monolayer.

In another preferred embodiment of the above tape, the first direction is the MD.

In another preferred embodiment of the above tape, the backing has a tensile elongation to break in the MD of at least 70%.

In another preferred embodiment of the above tape, the backing is hand-tearable in the TD. More preferably, the backing is also hand-tearable in the MD.

In another preferred embodiment of the above tape, when the backing is severed according to the Dispense Test, the backing has an energy to sever in the MD of up to 350 N-cm/cm². More preferably, the backing has an energy to sever in the MD of up to 170 N-cm/cm².

In another preferred embodiment of the above tape, when the backing is tested according to the Puncture Test, the backing has a puncture energy of up to 130 N-mm. More preferably, the backing has a puncture energy of up to 70 N-mm.

In yet another aspect, the present invention provides another alternative adhesive tape comprising a backing and a layer of adhesive on the backing. The backing comprises polypropylene, and has been biaxially stretched in the MD and TD. The backing has a tensile elongation to break in the MD of from 70% to 150% and is hand-tearable in the TD.

In one preferred embodiment of the above tape, the backing comprises a monolayer.

In another preferred embodiment of the above tape, when the backing is tested according to the Puncture Test, the backing has a puncture energy of up to 130 N-mm. More preferably, the backing has a puncture energy of up to 70 N-mm.

In another preferred embodiment of the above tape, when the backing is severed on a serrated plastic cutting blade, the backing exhibits a serrated edge that closely corresponds to the contour of the blade.

In another preferred embodiment of the above tape, when the backing is severed according to the Dispense Test, the backing has an energy to sever in the MD of up to 350 N-cm/cm². More preferably, the backing has an energy to sever in the MD of up to 170 N-cm/cm².

In another preferred embodiment of the above tape, the backing has a tensile energy to break in the MD of up to 90 N-mm/mm³.

In another preferred embodiment of the above tape, the backing is hand-tearable in the MD.

In still another aspect, the present invention provides another alternative adhesive tape comprising a backing and a layer of adhesive on the backing. The backing comprises polypropylene and has been biaxially stretched in the MD and TD. The backing is hand-tearable in the TD and in the MD.

In one preferred embodiment of the above tape, the backing comprises a monolayer.

In another preferred embodiment of the above tape, when the backing is tested according to the Puncture Test, the backing has a puncture energy of up to 130 N-mm. More preferably, the backing has a puncture energy of up to 70 N-mm.

In another preferred embodiment of the above tape, when the backing is severed on a serrated plastic cutting blade, the backing exhibits a serrated edge that closely corresponds to the contour of the blade.

In another preferred embodiment of the above tape, when the backing is severed according to the Dispense Test, the backing has an energy to sever in the MD of up to 350 N-cm/cm². More preferably, the backing has an energy to sever in the MD of up to 170 N-cm/cm².

In another preferred embodiment of the above tape, the backing has a tensile energy to break in the MD of up to 90 N-mm/mm³.

In another preferred embodiment of the above tape, the backing has a tensile elongation to break in the MD of at least 70%.

In any of the tapes described above, the backing preferably has an MD stretch ratio of at least 4:1.

In any of the tapes described above, the backing preferably has a TD stretch ratio of at least 7:1.

In any of the tapes described above, the backing preferably has an MD stretch ratio of at least 4:1 and a TD stretch ratio of at least 7:1.

The present invention provides films described above, tape backings made from such films, tapes including the backings, and methods of making the films, backings, and tapes.

Certain terms are used in the description and the claims that, while for the most part are well known, may require some explanation. “Biaxially stretched,” when used herein to describe a film, indicates that the film has been stretched in two different directions, a first direction and a second direction, in the plane of the film. Typically, but not always, the two directions are substantially perpendicular and are in the machine direction (“MD”) of the film (the direction in which the film is produced on a film-making machine) and the transverse direction (“TD”) of the film (the direction perpendicular to the MD of the film). The MD is sometimes referred to as the Longitudinal Direction (“LD”). Biaxially stretched films may be sequentially stretched, simultaneously stretched, or stretched by some combination of simultaneous and sequential stretching. “Simultaneously biaxially stretched,” when used herein to describe a film, indicates that significant portions of the stretching in each of the two directions are performed simultaneously. Unless context requires otherwise, the terms “orient,”“draw,” and “stretch” are used interchangeably throughout, as are the terms “oriented”, “drawn,” and “stretched,” and the terms “orienting,”“drawing,” and “stretching.”

The term “stretch ratio,” as used herein to describe a method of stretching or a stretched film, indicates the ratio of a linear dimension of a given portion of a stretched film to the linear dimension of the same portion prior to stretching. For example, in a stretched film having a MD stretch ratio (“MDR”) of 5:1, a given portion of unstretched film having a 1 cm linear measurement in the machine direction would have 5 cm measurement in the machine direction after stretch. In a stretched film having a TD stretch ratio (“TDR”) of 9:1, a given portion of unstretched film having a 1 cm linear measurement in the transverse direction would have 9 cm measurement in the transverse direction after stretch.

“Area stretch ratio,” as used herein, indicates the ratio of the area of a given portion of a stretched film to the area of the same portion prior to stretching. For example, in a biaxially stretched film having an overall area stretch ratio of 50:1, a given 1 cm² portion of unstretched film would have an area of 50 cm² after stretching.

The mechanical stretch ratio, also know as nominal stretch ratio, is determined by the unstretched and stretched dimensions of the overall film, and can typically be measured at the film grippers at the edges of the film used to stretch the film in the particular apparatus being used. Global stretch ratio refers to the overall draw ratio of the film after the portions that lie near the grippers, and thus are affected during stretching by the presence of the grippers, have been removed from consideration. The global stretch ratio can be equivalent to the mechanical stretch ratio when the input unstretched film has a constant thickness across its full width and when the effects of proximity to the grippers upon stretching are small. More typically, however, the thickness of the input unstretched film is adjusted so as to be thicker or thinner near the grippers than at the center of the film. When this is the case, the global stretch ratio will differ from the mechanical or nominal stretch ratio. These global or mechanical ratios are both to be distinguished from a local stretch ratio. The local stretch ratio is determined by measuring a particular portion of the film (for example a 1 cm portion) before and after stretch. When stretch is not uniform over substantially the entire edge-trimmed film, then the local ratio can be different from the global ratio. When stretch is substantially uniform over substantially the entire film (excluding the area immediately near the edges and surrounding the grippers along the edges), then the local ratio will be substantially equal to the global ratio. Unless the context requires otherwise, the term stretch ratio is used herein to describe the global stretch ratio.

### BRIEF DESCRIPTION OF THE DRAWINGS

The present invention will be further explained with reference to the appended Figures, wherein like structure is referred to by like numerals throughout the several views, and wherein:

FIG. 1 is an isometric view of a length of tape according to the present invention;

FIG. 2 is a side view of a roll of adhesive tape according to the present invention;

FIG. 3 is an isometric view of a test fixture used to test the severing characteristics of film according to the present invention;

FIG. 4 is an isometric view of the metal dispenser blade useful in the test fixture of FIG. 3;

FIG. 5 is a side view of the metal dispenser blade of FIG. 4;

FIG. 6 is a side view of a portion of the apparatus of FIG. 3 and the metal dispenser blade of FIG. 6;

FIG. 7 is an illustration of a typical severance or dispense testing curve for a polypropylene tape backing of the present invention;

FIG. 8 is an enlarged photograph of a polypropylene film according to the present invention (Example E5) severed according to the test method described herein; and

FIG. 9 is an enlarged photograph of a prior art polypropylene film (Example C1) severed according to the test method described herein.

### DETAILED DESCRIPTION OF THE INVENTION

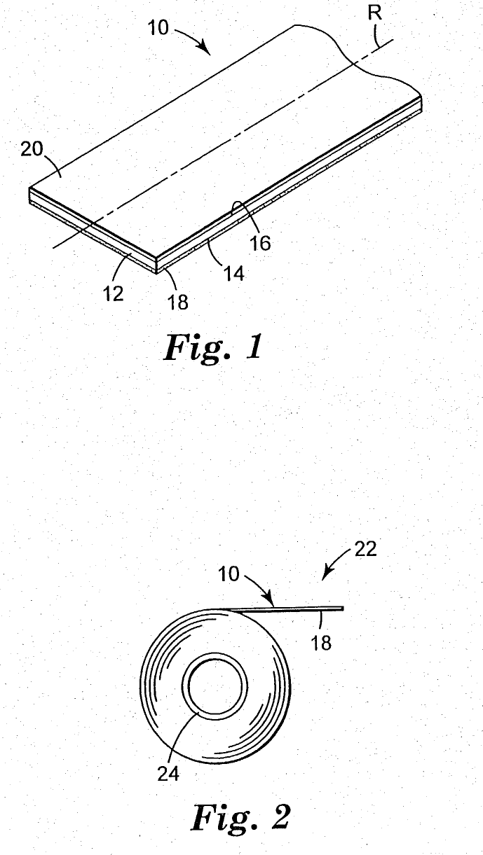

Referring to FIG. 1, there is shown a length of tape 10 according to one preferred embodiment of the present invention. Tape 10 comprises a biaxially oriented polypropylene film backing 12 which includes first major surface 14 and second major surface 16. Preferably, backing 12 has a thickness in the range of about 0.002 to about 0.006 centimeters. Backing 12 of tape 10 is coated on first major surface 14 with a layer of adhesive 18. Adhesive 18 may be any suitable adhesive as is known in the art. Backing 12 may have an optional release or low adhesion backsize layer 20 coated on the second major surface 16 as is known in the art.

The backing film 12 preferably comprises polypropylene. For the purposes of the present invention, the term “polypropylene” is meant to include copolymers comprising at least about 90% propylene monomer units, by weight. “Polypropylene” is also meant to include polymer mixtures comprising at least about 75% polypropylene, by weight. Polypropylene for use in the present invention is preferably predominantly isotactic. Isotactic polypropylene has a chain isotacticity index of at least about 80%, an n-heptane soluble content of less than about 15% by weight, and a density between about 0.86 and 0.92 grams/cm³ measured according to ASTM D1505-96 (“Density of Plastics by the Density-Gradient Technique”). Typical polypropylenes for use in the present invention have a melt flow index between about 0.1 and 15 grams/10 minutes according to ASTM D1238-95 (“Flow Rates of Thermoplastics by Extrusion Plastometer”) at a temperature of 230° C. and force of 2160 g, a weight-average molecular weight between about 100,000 and 400,000, and a polydispersity index between about 2 and 15. Typical polypropylenes for use in the present invention have a peak melting temperature as determined using differential scanning calorimetry of greater than about 130° C., preferably greater than about 140° C., and most preferably greater than about 150° C. Further, the polypropylenes useful in this invention may be copolymers, terpolymers, etc., having ethylene monomer units and/or alpha-olefin monomer units of between 4-8 carbon atoms, said comonomer(s) being present in an amount so as not to adversely affect the desired properties and characteristics of the backing and tapes described herein, typically their content being less than 10% by weight. One suitable polypropylene resin is an isotactic polypropylene homopolymer resin having a melt flow index of 2.5 g/10 minutes, commercially available under the product designation 3374 from FINA Oil and Chemical Co., Dallas, Tex.

Polypropylene for use in the present invention may optionally include, in an amount so as not to adversely affect the desired characteristics and properties described herein, a resin of synthetic or natural origin having a molecular weight between about 300 and 8000, and having a softening point between about 60° C. and 180° C. Typically, such a resin is chosen from one of four main classes: petroleum resins, styrene resins, cyclopentadiene resins, and terpene resins. Optionally, resins from any of these classes may be partially or fully hydrogenated. Petroleum resins typically have, as monomeric constituents, styrene, methylstyrene, vinyltoluene, indene, methylindene, butadiene, isoprene, piperylene, and/or pentylene. Styrene resins typically have, as monomeric constituents, styrene, methylstyrene, vinyltoluene, and/or butadiene. Cyclopentadiene resins typically have, as monomeric constituents, cyclopentadiene and optionally other monomers. Terpene resins typically have, as monomeric constitutents, pinene, alpha-pinene, dipentene, limonene, myrcene, and camphene.

Polypropylene for use in the present invention may optionally include additives and other components as is known in the art. For example, the films of the present invention may contain fillers, pigments and other colorants, antiblocking agents, lubricants, plasticizers, processing aids, antistatic agents, antioxidants and heat stabilizing agents, ultraviolet light stabilizing agents, and other property modifiers. Fillers and other additives are preferably added in an effective amount selected so as not to substantially affect the nucleation of the cast film and so as not to adversely affect the properties attained by the preferred embodiments described herein. Typically such materials are added to a polymer before it is made into an oriented film (e.g., in the polymer melt before extrusion into a film).

The polypropylene can be cast into sheet form by apparatus known to those of skill in the art, provided the polypropylene is cast in accordance with the preferred temperatures and methods described herein. Such cast films are then stretched to arrive at the preferred film described herein. When making polypropylene films, a suitable method for casting a sheet is to feed the resin into the feed hopper of a single screw, twin screw, cascade, or other extruder system having an extruder barrel temperature adjusted to produce a stable homogeneous melt. The polypropylene melt can be extruded through a sheet die onto a rotating cooled metal casting wheel. Optionally, the casting wheel can be partially immersed in a fluid-filled cooling bath, or, also optionally, the cast sheet can be passed through a fluid-filled cooling bath after removal from the casting wheel. The temperatures of this operation can be chosen by those of skill in the art with the benefit of the teachings herein to provide the desired nucleation density, size, and growth rate such that the resulting stretched film has the desired characteristics and properties described herein. These temperatures will vary with the material used, and with the heat transfer characteristics of the particular apparatus used. For one particular arrangement, the following temperatures are preferred. Preferably, the polypropylene composition is extruded at a temperature of about 245-250° C. Preferably, the cast roll is at a temperature of at least 90° C., more preferably approximately 90-94° C.

The sheet is then stretched to provide backing 12 having the desired characteristics and properties described herein. Preferably, the backing is biaxially stretched.

In one preferred sequential stretch embodiment, the MD stretch ratio is from about 4:1 to 6:1. More preferably, the MD stretch ratio is about 4.5:1 to about 5.5:1. In another preferred sequential stretch embodiment, the TD stretch ratio is at least 7:1. More preferably, the TD stretch ratio is from about 7:1 to about 12:1. In another preferred sequential stretch embodiment, the MD stretch ratio is from about 4:1 to about 6:1 and the TD stretch ratio is at least 7:1. More preferably, the MD stretch ratio is from about 4.5:1 to about 5.5:1 and the TD stretch ratio is from about 7:1 to about 11:1. One particularly preferred backing is one that is sequentially biaxially stretched having an MD stretch ratio of about 5:1 and a TD stretch ratio of about 8:1 to 10:1.

In one preferred simultaneously biaxial stretch embodiment, the area stretch ratio is from about 35:1 to about 108:1. More preferably, the area stretch ratio is from about 45:1 to about 60:1. The MD component and TD component of these embodiments is chosen so as to provide the desired film properties and characteristics described herein.

The preferred properties described herein may be obtained by any suitable apparatus for biaxially orienting the backing 12 according to the preferred methods described herein. Of all stretching methods, the apparatus preferred for commercial manufacture of films for tape backings include: known sequential biaxial stretching apparatus that typically stretches in the MD first by passing the film over a sequence of rotating rollers whose speed provides a higher output film line speed than input speed, followed by TD stretching in a tenter on diverging rails; simultaneous biaxial stretching by mechanical tenter such as the apparatus disclosed in U.S. Pat. Nos. 4,330,499 and 4,595,738; and the tenter apparatus for simultaneous biaxial stretch disclosed in U.S. Pat. Nos. 4,675,582; 4,825,111; 4,853,602; 5,036,262; 5,051,225; and 5,072,493. Although biaxially stretched films can be made by tubular blown film or flat film tenter stretching processes, it is preferable that the films of this invention, when used as tape backings, be made by a flat film stretching apparatus to avoid processing difficulties that may arise with tubular blown film processes.

The temperatures of the stretching operation can be chosen by those of skill in the art with the benefit of the teachings herein to provide a film having the desired characteristics and properties described herein. These temperatures will vary with the material used, and with the heat transfer characteristics of the particular apparatus used. For one preferred sequential stretch apparatus, it is preferred that the preheat roll and the stretch roll for the MD stretch be maintained at about 120-135° C. It is also preferred that for the TD stretch in the tenter, the preheat zone be maintained at about 180-190° C. and the stretch zone be maintained at about 160-177° C. For simultaneously stretched backings, it is preferred that the preheat and stretch be from approximately 170° C. to 200° C.

The backing 12 useful in this invention, when used as a backing for a tape 10, preferably has a final thickness between about 0.002-0.006 cm. Variability in film thickness is preferably less than about 5%. Thicker and thinner films may be used, with the understanding that the film should be thick enough to avoid excessive flimsiness and difficulty in handling, while not being so thick so as to be undesirably rigid or stiff and difficult to handle or use.

The polypropylene composition, extrusion temperature, cast roll temperature, and stretch temperature and other parameters are selected in according with the teachings herein such that the resulting backing or tape has the following preferred properties, taken individually or in any preferred combination:

A) an MD tensile energy at break of up to about 90 N-mm/mm³, more preferably from about 30 to 90 N-mm/mm³, still more preferably up to about 60 N-mm/mm³, and most preferably from about 30 to 60 N-mm/mm³;

B) an MD elongation to break of at least 70%, preferably from about 70 to 150%;

C) a puncture energy, when tested according to the Puncture Test described below, of up to about 130 N-mm, more preferably up to about 70 N-mm;

D) a dispense energy, when tested according to the Dispense Test described below of up to about 350 N-cm/cm²; more preferably up to about 170 N-cm/cm²;

E) when dispensed on commercially available serrated plastic or metal dispenser blades, the serrated edge of the tape or backing closely follows the contour of the dispensing blade;

F) an ability to be torn by hand in the TD, as defined by at least 50% success as described below. More preferably the backing or tape can be torn by hand with at least 90%, success as described below, and most preferably 100%; and

G) an ability to be torn by hand in the MD, as defined by at least 50% success as described below. More preferably the backing or tape can be torn by hand with at least 90% success as described below, and most preferably 100%.

The above properties and characteristics are described herein with respect to the preferred embodiments, and reported herein with respect to the examples, for a film or backing 12 without adhesive 18 thereon. It is expected that in most cases, the characteristics and properties are governed primarily by the backing, with little affect by the adhesive or other layers or coatings. Therefore, the above preferred characteristics and properties also apply to the adhesive tapes of the present invention.

One preferred embodiment of the present invention comprises a monolayer backing. As used herein, the term monolayer includes multiple layers of substantially the same material.

The adhesive 18 coated on the first major surface 14 of tape backing 12 may be any suitable adhesive as is known in the art. Preferred adhesives are those activatable by pressure, heat or combinations thereof. Suitable adhesives include those based on acrylate, rubber resin, epoxies, urethanes or combinations thereof. The adhesive 18 may be applied by solution, water-based or hot-melt coating methods. The adhesive can include hot melt-coated formulations, transfer-coated formulations, solvent-coated formulations, and latex formulations, as well as laminating, thermally-activated, and water-activated adhesives. Useful adhesives according to the present invention include all pressure sensitive adhesives. Pressure sensitive adhesives are well known to possess properties including: aggressive and permanent tack, adherence with no more than finger pressure, and sufficient ability to hold onto an adherend. Examples of adhesives useful in the invention include those based on general compositions of polyacrylate; polyvinyl ether; diene rubber such as natural rubber, polyisoprene, and polybutadiene; polyisobutylene; polychloroprene; butyl rubber; butadiene-acrylonitrile polymer; thermoplastic elastomer; block copolymers such as styrene-isoprene and styrene-isoprene-styrene (SIS) block copolymers, ethylene-propylene-diene polymers, and styrene-butadiene polymers; poly-alpha-olefin; amorphous polyolefin; silicone; ethylene-containing copolymer such as ethylene vinyl acetate, ethylacrylate, and ethyl methacrylate; polyurethane; polyamide; epoxy; polyvinylpyrrolidone and vinylpyrrolidone copolymers; polyesters; and mixtures or blends (continuous or discontinuous phases) of the above. Additionally, the adhesives can contain additives such as tackifiers, plasticizers, fillers, antioxidants, stabilizers, pigments, diffusing materials, curatives, fibers, filaments, and solvents. Also, the adhesive optionally can be cured by any known method.

A general description of useful pressure sensitive adhesives may be found in Encyclopedia of Polymer Science and Engineering, Vol. 13, Wiley-Interscience Publishers (New York, 1988). Additional description of useful pressure sensitive adhesives may be found in Encyclopedia of Polymer Science and Technology, Vol. 1, Interscience Publishers (New York, 1964).

The film backing 12 of the tape 10 may optionally be treated by exposure to flame or corona discharge or other surface treatments including chemical priming to improve adhesion of subsequent coating layers. In addition, the second surface 16 of the film backing 12 may be coated with optional low adhesion backsize materials 20 to restrict adhesion between the opposite surface adhesive layer 18 and the film 12, thereby allowing for production of adhesive tape rolls capable of easy unwinding, as is well known in the adhesive coated tape-making art. The tape 10 may be spirally wound to make a roll 22, optionally on core 24, as illustrated in FIG. 2.

The backings described herein are well-suited for many adhesive tape backing applications. Because the backing is conformable, it is useful as a masking tape backing. The backings are also well-suited for other applications including utility tapes and light duty box sealing tapes.

The operation of the present invention will be further described with regard to the following detailed examples. These examples are offered to further illustrate the various specific and preferred embodiments and techniques. It should be understood, however, that many variations and modifications may be made while remaining within the scope of the present invention.

Test Methods

Film Tensile Property Determinations

The machine direction (MD) tensile energy-at-break and the tensile elongation-at-break of the films were measured according to the procedures described in ASTM D-882, “Tensile Properties of Thin Plastic Sheeting,” Method A. The films were conditioned for 24 hours at 22° C. (72° F.) and 50 percent relative humidity (RH) prior to testing. The tests were performed using a tensile testing machine commercially available as a Model No. Sintech 400/S from MTS Systems Corporation, Eden Prairie, Minn. Specimens for this test were 1.25 cm wide and 15 cm long. An initial jaw separation of 5 cm and a crosshead speed of 50.8 cm/min were used. Ten specimens were tested for each sample in the MD.

Puncture-energy Determination

Puncture energy was determined using a Model No. Sintech 400/S tensile testing machine manufactured by MTS Systems Corporation, Eden Prairie, Minn. A clamp assembly, consisting of two rigid plates having a 7.62-cm diameter hole in the center of each plate, was used. A plunger, consisting of a 0.318-cm diameter steel rod having a hemispherical tip, was utilized. Displacement of the plunger assembly was measured during loading and complete penetration of each test specimen. Specimens for testing were cut parallel to the MD into 1.9 cm wide strips. Specimens were 12.7 cm in length in order to be adequately gripped in the clamp assembly. Each test was performed at a speed of 254 cm/min. At least five specimens were tested for each determination.

For each test, the specimen was clamped into the assembly. Each specimen was centered across the plate opening. A piece of pressure-sensitive adhesive tape was used to hold the sample onto one side of the bottom plate of the clamp assembly while a weight (75 g) was hung on the other side of the specimen so as to ensure that the sample was loaded under constant tension. The clamping plate was then tightened using thumb screws so that the sample did not slip during the test. The clamp assembly was positioned under the plunger so that the path of the plunger was through the center of the sample. The total energy required to puncture the sample was determined.

As used herein, including the claims, the term “Puncture Test” refers to the just-described test.

TD Hand-Tear Determination

Ten specimens of film were cut parallel to the MD to a width of 2.5 cm using a razor cutter. Thus the samples had a smooth edge, that is one that does not include intentional irregularities, roughness, flaws, or other tear-initiation sites. Hand-tearing along the TD was attempted 10 times at 22° C. The percentage of successful tears is considered to indicate the TD tear property.

MD Hand-Tear Determination

Ten specimens of film were cut parallel to the TD to a width of 2.5 cm using a razor cutter. Thus the samples had a smooth edge, that is one that does not include intentional irregularities, roughness, flaws, or other tear-initiation sites. Hand-tearing along the MD was attempted 10 times at 22° C. The percentage of successful tear initiation and propagation is considered to indicate the MD tear property.

Determination of Appearance of the Serrated Edge on a Film

Films produced according to this invention and comparative films described herein were dispensed on a serrated plastic blade (3M Catalog #105 available as of the filing date hereof from Minnesota Mining and Manufacturing Company, St. Paul, Minn.). Films dispensed against this blade were photographed using a Model Laborlux 12 POL microscope manufactured by Leitz of Wetzlar, Germany. The samples were examined between crossed polarizers having a ¼-wavelength-shift plate and using a magnification of 50 times. It was observed that each of the inventive Examples E1 through E5 had a serrated edge the closely followed the contour of the plastic cutting blade. Each of the comparative Examples C1 through C7 had a serrated edge that was irregular and did not closely follow the contour of the cutting blade.

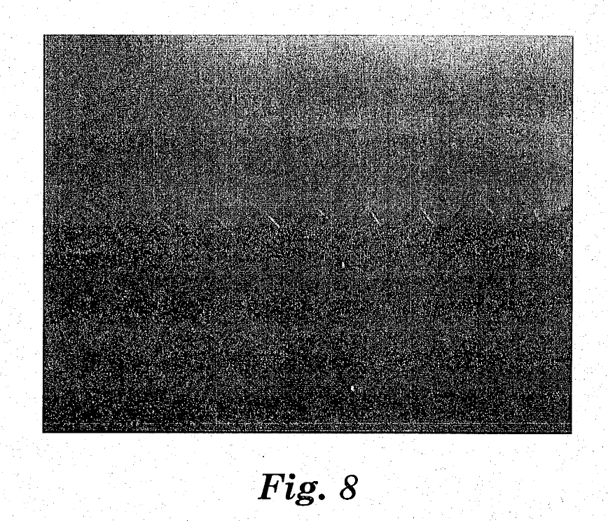

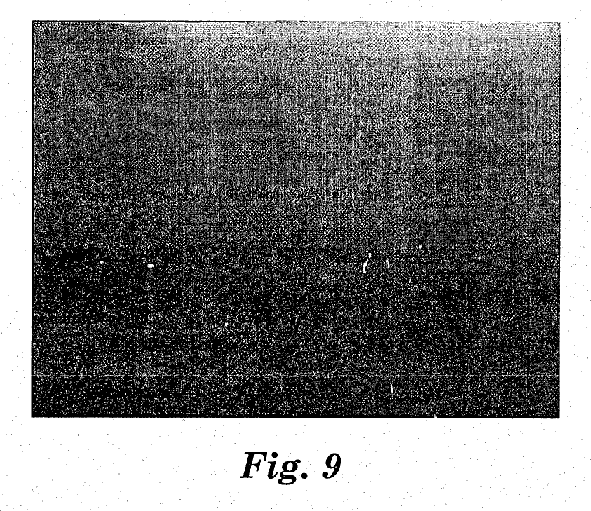

FIG. 8 is a 10× enlarged photograph of a polypropylene film according to the present invention, Example E5. It is seen that the serrated edge of the severed backing closely follows the contour of the plastic cutting blade. FIG. 9 is a 10× enlarged photograph of a prior art polypropylene film Example C1. It is seen that the serrated edge does not closely follow the contour of the cutting teeth of the plastic dispenser blade.

Severance Properties: Dispense Testing of Films

Test specimens 1.91 cm wide and 15 cm long were slit from uncoated sample films using a razor blade cutter equipped with new blades. Test specimens were conditioned for 24 hours at 25° C. and 50% relative humidity prior to testing.

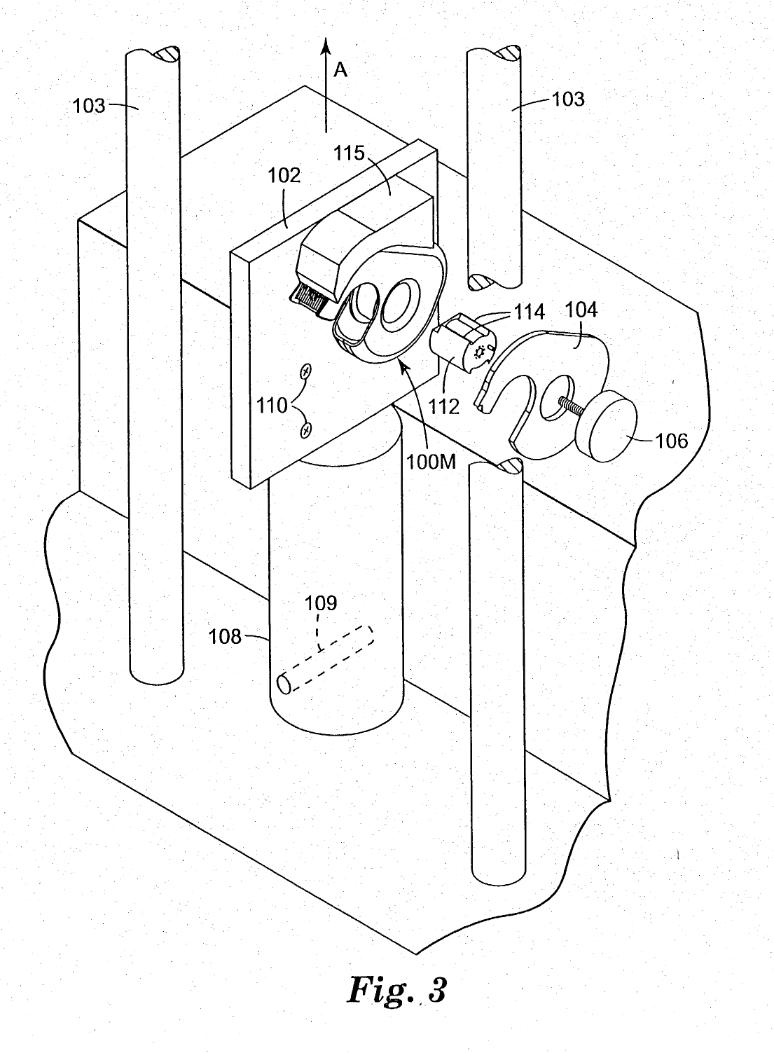

The test fixture used to measure severability is shown in FIG. 3. The test fixture comprised a commercially available tape dispenser 100M (Scotch™ Cat. H-127 two-piece polystyrene molded dispenser equipped with a metal cutting blade, available as of the filing date hereof from Minnesota Mining & Manufacturing Co., St. Paul, Minn.) mounted to a 15.2 cm×15.2 cm×1.1 cm aluminum rear mounting plate 102. The dispenser was restricted from flexing during the severing test by being placed between the rear mounting plate 102 and a 0.3 cm thick aluminum front mounting plate 104 milled to the contour of the test dispenser 100M. The test dispenser was firmly held in place between the front 104 and rear 102 mounting plates by a threaded thumbscrew 106. The rear mounting plate 102 was affixed to a 2.4 cm diameter cylindrical base mounting stud 108 by machine screws 110. The base mounting stud 108 was milled to include a 90° angle cut-out so that the rear mounting plate 102 was held in the vertical centerline of the tensile testing machine, that is, the angle between the axis of the rear mounting plate 102 and test dispenser 100M was 0° with respect to the machine centerline. The base stud 108 was affixed to the testing machine deck by locking pins inserted into drillouts 109 in the base stud.

The test dispenser 100M was mounted onto the rear mounting plate 102 by inserting the dispenser hub over an aluminum hub mounting shaft 112 which is screwed into the rear mounting plate 102. The bottom of the dispenser rested against seat 115 which prevented rotation of the dispenser during testing. The test dispenser was mounted so that the row of teeth of the dispenser cutting blade was perpendicular to the machine centerline. In this way, the film being tested was loaded substantially uniformly across its width when severed.

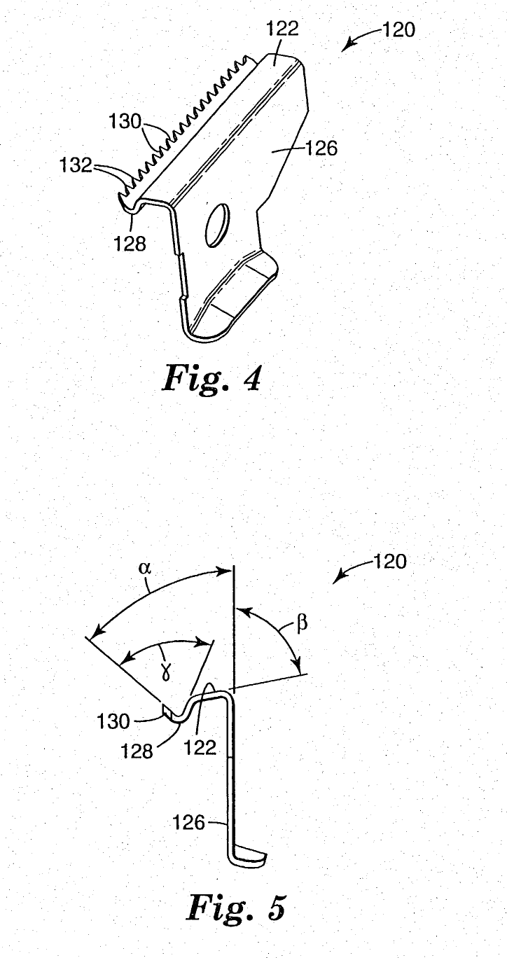

Dispenser 100M included a steel serrated cutting blade 120 illustrated in FIGS. 4 and 5. Steel cutting blade 120 was formed of about 0.05 cm thick nickel plated steel and included a rectangular land portion 122 at least as wide as the film 12 and about 0.3 cm long in the direction corresponding to the reference direction R of the film 12 extending across the blade. The land portion 122 defines a generally planar surface to which the test sample is temporarily secured. Blade 120 also included a blade support portion 126 at the rear edge of the land portion 122, with the land portion forming an angle β of 80° with the support 126. Blade support 126 is about 1.32 cm long. Blade 120 further included a generally U-shaped portion 128 at the edge of the land portion opposite the support portion which has a row of teeth 130 along its distal edge. Each tooth 130 is generally triangular, has a tip in or slightly lower than the plane of the land 122 and spaced from the tips of adjacent teeth 130 by about 0.12 cm, is defined by a height of about 0.06 cm, a sharpness defined by a radius of curvature of about 0.003 cm, and the apex 132 of said teeth 130 form an included angle of 60°. The teeth 130 project outward from the plane of the blade support portion 126 at an angle α of about 50°. The sides of the generally U-shaped portion 128 are at an angle γ to one another of 72°.

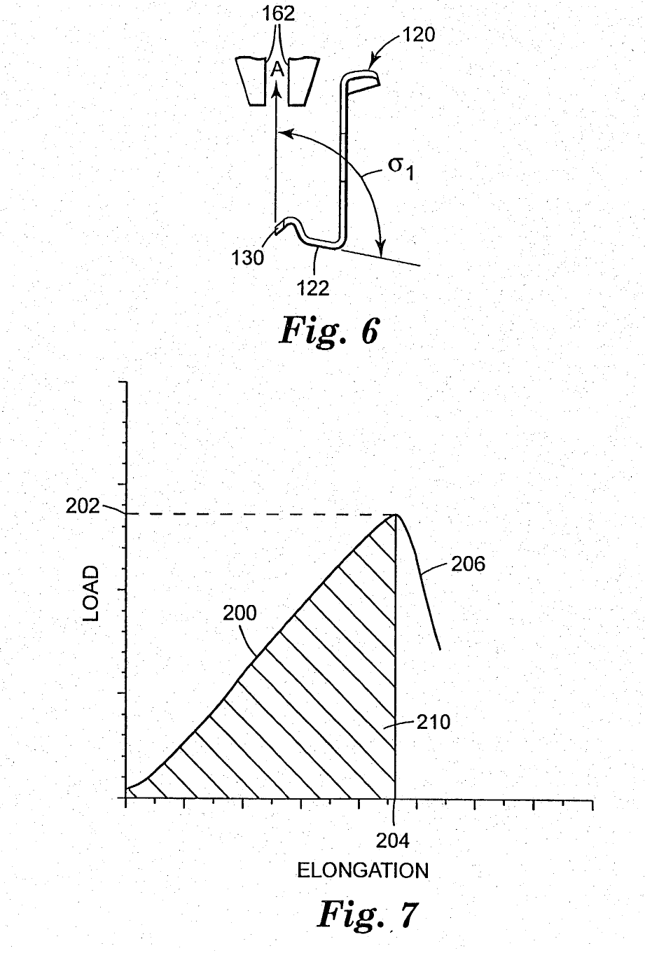

A piece of double-coated adhesive tape (Scotch™ Cat. 665) was applied to land area 122 and the test specimen was adhered firmly to the adhesive surface of the double-coated tape with finger pressure to prevent forward motion during severance testing. The test specimen was aligned at an angle of 0° to the machine centerline so that the force of the dispenser was substantially evenly distributed across the width of the sample. The dispenser 100M was oriented such that the tips of the cutting blade 120 were directly under the jaws 162. The dispenser was oriented at an angle such that the land 122 was at an angle σ₁ of 110° relative to the vertical direction of travel A of the tester (see FIG. 6, which illustrates only the cutter blade 120 relative to the jaws 162, with the rest of the dispenser and test fixture removed for illustrative purposes only).

The free end of the test specimen was then gripped in the upper jaws 162 of the tensile testing machine so that the distance between the upper jaws and the cutting blade 120 was 10.2 cm. The specimen was loaded with no tension so that the cutting blade did not contact the specimen prior to the start of the test. The upper jaws were attached to the machine crosshead which traveled on support rails 103. The test specimen was next pre-loaded in tension to a value of 0.9 N to make contact with the cutting blade 120. The backing 12 was then pulled in direction A by the jaws 162 at a rate of 30 cm/minute. The load and elongation of the specimen were measured and recorded, and the energy to sever was calculated from the area under the load/elongation, as illustrated in FIG. 7, and reported in Table 2. In FIG. 7, the load is indicated along the vertical axis, with the elongation indicated on the horizontal axis. The load and elongation increase along portion 200 of the curve, until the peak load 202 is reached, where the elongation is indicated by 204. The load then decreases as the elongation continues along portion 206 of the curve. As reported herein, the energy is calculated for that portion of the curve from zero elongation to the elongation 204 at maximum load 202. It is believed that the teeth of the dispenser puncture the film at about the point of maximum load 202, at which time the load decreases as the punctures through the film propagate to complete severance.

As used herein, including the claims, the term “Dispense Test” refers to the just described test.

### PREPARATION OF EXAMPLES

### Example E1

A single-layer film having a final thickness of 0.030 mm was prepared by extruding a polypropylene homopolymer having a melt flow index of 2.8 grams/10 minutes at 230° C. and 2160 g loading (ASTM D1238) and having a melting temperature of 157.8° C. The extruded film was taken off onto a casting roll and cooled, longitudinally stretched, then transversely stretched, and heat set.

### Example E2

A single-layer film having a final thickness of 0.033 mm was prepared by extrusion of a polypropylene homopolymer having a melt flow index of 1.8 g/10 min at 230° C. and 2160 g loading (ASTM D1238) and having a melting temperature of 164.0° C. The extruded film was taken off onto a casting roll and cooled, longitudinally stretched, transversely stretched, and heat set.

### Example E3

A single-layer film having a final thickness of 0.020 mm was prepared by extrusion of a polypropylene homopolymer having a melt flow index of 2.5 g/10 min at 230° C. and 2160 g loading and having a melting temperature of 161.5° C. The extruded film was taken off onto a casting roll and cooled. The extruded film was then stretched simultaneously in both the longitudinal and transverse directions.

### Example E4

Example E4 was prepared as reported for Example E3, except for final thickness which was 0.022 mm, and the stretch ratios.

### Example E5

A single-layer film having a final thickness of 0.036 mm was prepared by extrusion of a polypropylene homopolymer having a melt flow index of 2.5 g/10 min at 230° C. and 2160 g loading and having a melting temperature of 161.5° C. The extruded film was taken off onto a casting roll and cooled, longitudinally stretched, transversely stretched, and heat set.

### Comparative Example C1

A single-layer film having a final thickness of 0.030 mm was prepared by extrusion of a polypropylene homopolymer having a melt flow index of 2.8 g/10 min at 230° C. and 2160 g loading (ASTM D1238) and having a melting temperature of 157.8° C. The extruded film was taken off onto a casting roll and cooled, longitudinally stretched, transversely stretched, and heat set.

### Comparative Example C2

A single-layer film having a final thickness of 0.039 mm was prepared by extrusion of a polypropylene homopolymer having a melt flow index of 2.5 g/10 min at 230° C. and 2160 g loading and having a melting temperature of 161.5° C. The extruded film was taken off, onto a casting roll and cooled, longitudinally stretched, transversely stretched, and heat set.

### Comparative Example C3

A single-layer film having a final thickness of 0.038 mm was prepared by extrusion of a polypropylene homopolymer having a melt flow index of 2.5 g/10 min at 230° C. and 2160 g loading and having a melting temperature of 161.5° C. The extruded film was taken off onto a casting roll and cooled, longitudinally stretched, transversely stretched, and heat set.

### Comparative Example C4

A single-layer film having a final thickness of 0.038 mm was prepared by extrusion of a polypropylene homopolymer having a melt flow index of 2.5 g/10 min at 230° C. and 2160 g loading and having a melting temperature of 161.5° C. The extruded film was taken off onto a casting roll and cooled, longitudinally stretched, transversely stretched, and heat set.

### Comparative Example C5

A single-layer film having a final thickness of 0.038 mm was prepared by extrusion of a polypropylene homopolymer having a melt flow index of 2.5 g/10 min at 230° C. and 2160 g loading and having a melting temperature of 161.5° C. The extruded film was taken off onto a casting roll and cooled, longitudinally stretched, transversely stretched, and heat set.

### Comparative Example C6

A single-layer film having a final thickness of 0.031 mm was prepared by extrusion of a polypropylene homopolymer having a melt flow index of 2.5 g/10 min at 230° C. and 2160 g loading and having a melting temperature of 161.5° C. The extruded film was taken off onto a casting roll and cooled. The extruded film was then stretched simultaneously in both the longitudinal and transverse directions.

### Comparative Example C7

Comparative Example C7 was prepared as reported for C6, except for the final thickness which was 0.028 mm and the stretch ratios.

The examples were prepared as set forth in Table 1 below. The stretch ratios indicated are global stretch ratios. Certain of the Examples were tested by certain of the methods described above. Results of such testing are reported in Table 2 below.

TABLE 1

| | | | | | Sequential Stretch | | | | | | |
|---|---|---|---|---|---|---|---|---|---|---|---|
| | | | | | | | | | | Simultaneous | |
| | | | MD | TD | MD Stretch | | TD Stretch | | | Stretch | |
| | Extrusion | Cast Roll | Stretch | Stretch | Preheat | Stretch | Preheat | Stretch | Heat Set | Preheat | Stretch |
| Ex. | (° C.) | (° C.) | Ratio | Ratio | Roll (° C.) | Roll (° C.) | Zone (° C.) | Zone (° C.) | (° C.) | (° C.) | (° C.) |
| E1 | 250 | 90 | 5:1 | 9:1 | 130 | 130 | 184 | 160 | 160 | — | — |
| E2 | 245 | 90 | 5:1 | 11:1 | 135 | 135 | 180 | 177 | 146 | — | — |
| E3 | 245 | 90 | 5:1 | 9:1 | — | — | — | — | — | 170 | 170 |
| E4 | 245 | 90 | 7:1 | 7:1 | — | — | — | — | — | 170 | 170 |
| E5 | 245 | 94 | 5:1 | 10:1 | 135 | 135 | 190 | 174 | 145 | — | — |
| C1 | 250 | 34 | 5:1 | 9:1 | 125-134 | 136 | 177 | 159 | 160 | — | — |
| C2 | 245 | 50 | 5:1 | 8.7:1 | 135 | 135 | 165 | 165 | 145 | — | — |
| C3 | 245 | 50 | 5:1 | 9:1 | 135 | 135 | 180 | 165 | 145 | — | — |
| C4 | 245 | 80 | 5:1 | 18.3:1 | 135 | 135 | 165 | 165 | 145 | — | — |
| C5 | 245 | 80 | 5:1 | 18.7:1 | 135 | 135 | 180 | 165 | 145 | — | — |
| C6 | 245 | 90 | 5:1 | 9:1 | — | — | — | — | — | 160 | 160 |
| C7 | 245 | 90 | 7:1 | 7:1 | — | — | — | — | — | 160 | 160 |

TABLE 2

| | MD Tensile | MD Tensile | | Dispense | TD | MD |
|---|---|---|---|---|---|---|
| | energy to | elongation | Puncture | Energy | Hand | Hand |
| | break | to break | Energy | (N-cm/ | Tear | Tear |
| Ex. | (N-mm/mm³) | (%) | (N-mm) | cm²) | (%) | (%) |
| E1 | 32 | 70 | 69 | 167 | 100 | 100 |
| E2 | 62 | 145 | 7 | 155 | 100 | 100 |
| E3 | 57 | 74 | — | — | 90 | — |
| E4 | 62 | 73 | — | — | — | 100 |
| E5 | 89 | 145 | 127 | 322 | 100 | 100 |
| C1 | 130 | 136 | 719 | 519 | 30 | 10 |
| C2 | 170 | 141 | 529 | 455 | 0 | 0 |
| C3 | 160 | 138 | 542 | 360 | 0 | 0 |
| C4 | 150 | 137 | 565 | 355 | 0 | 0 |
| C5 | 100 | 122 | 260 | 500 | 30 | 0 |
| C6 | 120 | 104 | — | — | — | 0 |
| C7 | 144 | 95 | — | — | — | 0 |

The tests and test results described above are intended solely to be illustrative, rather than predictive, and variations in the testing procedure can be expected to yield different results.

The present invention has now been described with reference to several embodiments thereof. The foregoing detailed description and examples have been given for clarity of understanding only. No unnecessary limitations are to be understood therefrom. All patents and patent applications cited herein are hereby incorporated by reference. It will be apparent to those skilled in the art that many changes can be made in the embodiments described without departing from the scope of the invention. Thus, the scope of the present invention should not be limited to the exact details and structures described herein, but rather by the structures described by the language of the claims, and the equivalents of those structures.

What is claimed is:

1. An adhesive tape, comprising:
a backing and a layer of adhesive on said backing, wherein said backing comprises polypropylene, wherein said backing has been biaxially oriented in the MD and TD of said backing, and wherein backing is hand-tearable in the TD, and wherein when said backing is severed on a serrated plastic cutting blade, said backing exhibits a serrated edge that closely corresponds to the contour of the blade.

2. The adhesive tape of claim 1, wherein said backing comprises a monolayer.

3. The adhesive tape of claim 1, wherein when said backing is severed according to the Dispense Test, said backing has an energy to sever in the MD of up to 350 N-cm/cm².

4. The adhesive tape of claim 3, wherein when said backing is severed according to the Dispense Test, said backing has an energy to sever in the MD of up to 170 N-cm/cm².

5. The adhesive tape of claim 1, wherein when said backing is tested according to the Puncture Test, said backing has a puncture energy of up to 130 N-mm.

6. The adhesive tape of claim 5, wherein when said backing is tested according to the Puncture Test, said backing has a puncture energy of up to 70 N-mm.

7. The adhesive tape of claim 1, wherein said backing has a tensile energy to break in the MD of up to 90 N-mm/mm³.

8. The adhesive tape of claim 1, wherein said backing has a tensile elongation to break in the MD of at least 70%.

9. The adhesive tape of claim 1, wherein said backing has an MD stretch ratio of at least 4:1.

10. The adhesive tape of claim 1, wherein said backing has a TD stretch ratio of at least 7:1.

11. The adhesive tape of claim 1, wherein said backing has an MD stretch ratio of at least 4:1 and a TD stretch ratio of at least 7:1.

12. The adhesive tape of claim 1, wherein said backing is hand-tearable in the MD.

13. An adhesive tape, comprising:
a backing and a layer of adhesive on said backing, wherein said backing comprises polypropylene, wherein said backing has been biaxially stretched, and wherein said backing has a tensile energy to break in a first direction of up to 90 N-mm/mm³, and wherein when said backing is severed on a serrated plastic cutting blade, said backing exhibits a serrated edge that closely corresponds to the contour of the blade.

14. The adhesive tape of claim 13, wherein said backing comprises a monolayer.

15. The adhesive tape of claim 13, wherein said first direction is the MD.

16. The adhesive tape of claim 15, wherein said backing has a tensile elongation to break in the MD of at least 70%.

17. The adhesive tape of claim 15, wherein said backing is hand-tearable in the TD.

18. The adhesive tape of claim 17, wherein said backing is hand-tearable in the MD.

19. The adhesive tape of claim 15, wherein when said backing is severed according to the Dispense Test, said backing has an energy to sever in the MD of up to 350 N-cm/cm².

20. The adhesive tape of claim 19, wherein when said backing is severed according to the Dispense Test, said backing has an energy to sever in the MD of up to 170 N-cm/cm².

21. The adhesive tape of claim 13, wherein when said backing is tested according to the Puncture Test, said backing has a puncture energy of up to 130 N-mm.

22. The adhesive tape of claim 21, wherein when said backing is tested according to the Puncture Test, said backing has a puncture energy of up to 70 N-mm.

23. The adhesive tape of claim 15, wherein said backing has an MD stretch ratio of at least 4:1.

24. The adhesive tape of claim 15, wherein said backing has a TD stretch ratio of at least 7:1.

25. The adhesive tape of claim 15, wherein said backing has an MD stretch ratio of at least 4:1 and a TD stretch ratio of at least 7:1.

26. An adhesive tape, comprising:
a backing and a layer of adhesive on said backing, wherein said backing comprises polypropylene, wherein said backing has been biaxially stretched in the MD and TD, wherein said backing has a tensile elongation to break in the MD of from 70% to 150%, and wherein said backing is hand-tearable in the TD.

27. The adhesive tape of claim 26, wherein said backing comprises a monolayer.

28. The adhesive tape of claim 26, when said backing is tested according to the Puncture Test, said backing has a puncture energy of up to 130 N-mm.

29. The adhesive tape of claim 28, wherein when said backing is tested according to the Puncture Test, said backing has a puncture energy of up to 70 N-mm.

30. The adhesive tape of claim 26, wherein when said backing is severed on a serrated plastic cutting blade, said backing exhibits a serrated edge that closely corresponds to the contour of the blade.

31. The adhesive tape of claim 26, wherein when said backing is severed according to the Dispense Test, said backing has an energy to sever in the MD of up to 350 N-cm/cm².

32. The adhesive tape of claim 31, wherein when said backing is severed according to the Dispense Test, said backing has an energy to sever in the MD of up to 170 N-cm/cm².

33. The adhesive tape of claim 26, wherein said backing has a tensile energy to break in the MD of up to 90 N-mm/mm³.

34. The adhesive tape of claim 26, wherein said backing is hand-tearable in the MD.

35. The adhesive tape of claim 26, wherein said backing has an MD stretch ratio of at least 4:1.

36. The adhesive tape of claim 26, wherein said backing has a TD stretch ratio of at least 7:1.

37. The adhesive tape of claim 26, wherein said backing has an MD stretch ratio of at least 4:1 and a TD stretch ratio of at least 7:1.

38. An adhesive tape, comprising:
a backing and a layer of adhesive on said backing, wherein said backing comprises polypropylene, wherein said backing has been biaxially stretched in the MD and TD, wherein said backing is hand-tearable in the TD, and wherein said backing is hand-tearable in the MD.

39. The adhesive tape of claim 38, wherein said backing comprises a monolayer.

40. The adhesive tape of claim 38, when said backing is tested according to the Puncture Test, said backing has a puncture energy of up to 130 N-mm.

41. The adhesive tape of claim 40, wherein when said backing is tested according to the Puncture Test, said backing has a puncture energy of up to 70 N-mm.

42. The adhesive tape of claim 38, wherein when said backing is severed on a serrated plastic cutting blade, said backing exhibits a serrated edge that closely corresponds to the contour of the blade.

43. The adhesive tape of claim 38, wherein when said backing is severed according to the Dispense Test, said backing has an energy to sever in the MD of up to 350 N-cm/cm².

44. The adhesive tape of claim 43, wherein when said backing is severed according to the Dispense Test, said backing has an energy to sever in the MD of up to 170 N-cm/cm².

45. The adhesive tape of claim 38, wherein said backing has a tensile energy to break in the MD or up to 90 N-mm/mm³.

46. The adhesive tape of claim 38, wherein said backing has a tensile elongation to break in the MD of at least 70%.

47. The adhesive tape of claim 38, wherein said backing has an MD stretch ratio of at least 4:1.

48. The adhesive tape of claim 38, wherein said backing has a TD stretch ratio of at least 7:1.

49. The adhesive tape of claim 38, wherein said backing has an MD stretch ratio of at least 4:1 and a TD stretch ratio of at least 7:1.
